(19) United States
(12) Patent Application Publication
(10) Pub. No.: US 2026/0338000 A1
(43) Pub. Date: Oct. 29, 2026

(54) DOMESTIC APPLIANCE AND A HANDLE ASSEMBLY THEREOF

(71) Applicant: Haier US Appliance Solutions, Inc., Wilmington, DE (US)

(72) Inventors: Balaji Kesana, Bapatla (IN); Rambabu Koppineni, Louisville, KY (US)

(21) Appl. No.: 19/187,176

(22) Filed: Apr. 23, 2025

(51) Int. Cl. E05B 1/00; F25D 23/02

(52) U.S. Cl. CPC E05B 1/0015; E05Y 2900/31; F25D 23/028

(57) ABSTRACT

A domestic appliance may include a cabinet. The domestic appliance may include a door providing selective access to an interior of the cabinet. The domestic appliance may include a handle assembly attached to the door. The handle assembly may include a handle tube. The handle assembly may include an end cap positioned between the door and the handle tube for securing the handle tube to the door. The end cap defining a through hole. The handle assembly may include a bushing received within the through hole. The bushing may include a projection disposed at an end of the bushing. The projection may be extended into the handle tube.

### FIELD OF THE DISCLOSURE

The present subject matter relates generally to a domestic appliance, and more particularly to a handle assembly for a domestic appliance.

### BACKGROUND OF THE DISCLOSURE

Domestic appliances (e.g., refrigerators, ovens, microwaves, etc.) typically include doors to open and close certain receiving spaces or drawers. For example, a user may open and close the doors or drawer to facilitate selective access to the interior storage space and easy storage of items. These doors (or drawers) include handles attached thereto which can be grasped and pulled by a user to gain access to the receiving space via the door or drawer. The handles include connection points at which the handle is connected to the appliance (e.g., the door or drawer).

However, with some current handle assemblies, handle endcaps are exposed to various cleaning and food elements that may result in environmental stress cracking. This cracking can lead to failure of the plastic end cap and poor performance of the handle from the appliance. Other designs could use an endcap manufactured from a material that is not subject to environmental stress cracking, such as metal. However, this would be significantly more expensive. In addition, conventional mounting methods include no way to ensure proper installation of the handle.

Accordingly, a handle assembly that obviates one or more of the above-mentioned drawbacks is desirable.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a domestic appliance is provided. The domestic appliance may include a door providing selective access to an interior of the cabinet. The domestic appliance may include a handle assembly attached to the door. The handle assembly may include a handle tube. The handle assembly may include an end cap positioned between the door and the handle tube for securing the handle tube to the door. The end cap defining a through hole. The handle assembly may include a bushing received within the through hole. The bushing may include a projection disposed at an end of the bushing. The projection may be extended into the handle tube. bushing, the projection extended into the handle tube.

In another exemplary aspect of the present disclosure, a handle assembly for a domestic appliance is provided. The domestic appliance may include a cabinet and a door providing selective access to an interior of the cabinet. The handle assembly may include a handle tube. The handle assembly may include an end cap positionable between the door and the handle tube for securing the handle tube to the door. The end cap may define a through hole. The handle assembly may include a bushing received within the through hole. The bushing may extend between a first end and a second end. The bushing may include a projection disposed at the first end. The projection may be extended into the handle tube. The projection may be engageable with an inner wall of the handle tube during an end cap failure condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to one or more exemplary embodiments of the present subject matter.

FIG. 2 provides a plan view of a handle assembly of the example refrigerator appliance of FIG. 1 according to one or more exemplary embodiments of the present subject matter.

FIG. 3 provides a top, cross-sectional view of a portion of the exemplary handle assembly of FIG. 2 according to one or more exemplary embodiments of the present subject matter.

FIG. 4 provides a top, cross-sectional view of a portion of the exemplary handle assembly of FIG. 2 according to one or more exemplary embodiments of the present subject matter.

FIG. 5 provides a sectional view of the exemplary handle assembly of FIG. 2 according to one or more exemplary embodiments of the present subject matter.

FIG. 6 provides a perspective view of an end cap and a bushing of the exemplary handle assembly of FIG. 2 according to one or more exemplary embodiments of the present subject matter.

FIG. 7 provides a perspective view of an end cap of the exemplary handle assembly of FIG. 2 according to one or more exemplary embodiments of the present subject matter.

FIG. 8 provides a perspective view of a bushing of the exemplary handle assembly of FIG. 2 according to one or more exemplary embodiments of the present subject matter.

FIG. 9 provides a perspective view of a bushing of the exemplary handle assembly of FIG. 2 according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Aspects of the present disclosure are generally directed to a domestic appliance, and more particularly, to a handle assembly for a domestic appliance, for example, a handle assembly for a refrigerator appliance. The handle assembly can include a bushing and an end cap for securing a handle tube to a door of the domestic appliance. A set screw type attachment can be utilized for mechanically restraining or attaching the handle tube to the bushing and the end cap, and thus, the door of the domestic appliance. The bushing can include a retention feature (e.g., a projection) that is extended into a hollow portion of the handle tube. In the event of a failure condition of the end cap (e.g., cracking that may lead to failure of the plastic end cap), the retention feature of the bushing may provide a secondary support for the handle tube as it advantageously engages with an inner wall of the handle tube to prevent the handle assembly from losing all functionality.

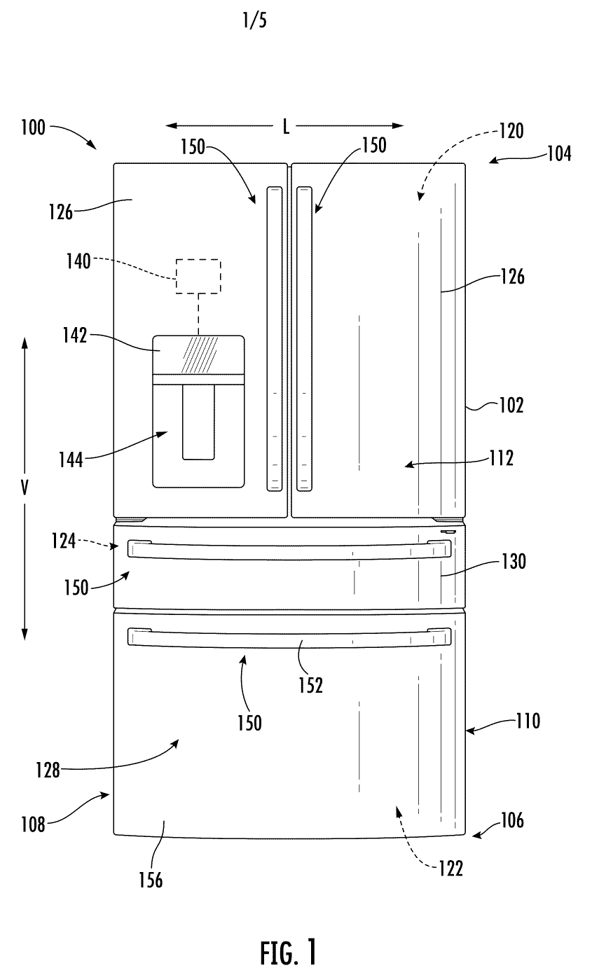

FIG. 1 provides a perspective view of a refrigerator appliance 100 according to an exemplary embodiment of the present subject matter. Refrigerator appliance 100 includes a housing or cabinet 102 that extends between a top 104 and a bottom 106 along a vertical direction V, between a first side 108 and a second side 110 along a lateral direction L, and between a front side 112 and a rear side (not shown) along a transverse direction T. Each of the vertical direction V, lateral direction L, and transverse direction T are mutually perpendicular to one another and form an orthogonal direction system.

Cabinet 102 defines chilled chambers for receipt of food items for storage. In particular, cabinet 102 defines fresh food chamber 120 positioned at or adjacent top 104 of cabinet 102 and a freezer chamber 122 arranged at or adjacent bottom 106 of cabinet 102. An auxiliary food storage chamber 124 may be positioned between the fresh food storage chamber 120 and the freezer chamber 122, e.g., along the vertical direction V. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applicable to any suitable appliance including a handle. Consequently, the description set forth herein is for illustrative purposes only and is not intended to be limiting in any aspect to any particular appliance or configuration.

Refrigerator doors 126 are rotatably hinged to an edge of cabinet 102 for selectively accessing fresh food chamber 120. In addition, a freezer door 128 and an auxiliary door 130 are arranged below refrigerator doors 126 for selectively accessing freezer chamber 122. Freezer door 128 is coupled to a freezer drawer (not shown) slidably mounted within freezer chamber 122. To prevent leakage of cool air, refrigerator doors 126, freezer door 128, auxiliary door 130, or cabinet 102 may define one or more sealing mechanisms (e.g., rubber gaskets, not shown) at the interface where the doors 126, 128, 130 meet cabinet 102. It should be appreciated that doors having a different style, position, or configuration are possible within the scope of the present subject matter.

In the exemplary embodiment, cabinet 102 may also define a mechanical compartment (not shown) for receipt of a sealed cooling system (not shown). In general, the sealed cooling system is configured for transporting heat from the inside of refrigerator appliance 100 to the outside (e.g., by executing a vapor-compression cycle or another suitable refrigeration cycle). As is generally understood by those of skill in the art, the hermetically sealed system contains a working fluid, e.g., refrigerant, which flows between various heat exchangers of the sealed system where the working fluid changes phases while transferring thermal energy. Further details regarding the operation of the sealed system are omitted here for brevity.

Operation of the refrigerator appliance 100 can be regulated by a controller 140 that is operatively coupled to a user interface panel 142. User interface panel 142 may provide selections for user manipulation of the operation of refrigerator appliance 100 to modify environmental conditions therein, such as temperature selections, etc. In some embodiments, user interface panel 142 may be proximate a dispenser assembly 144. In response to user manipulation of the user interface panel 142, the controller 140 may operate various components of the refrigerator appliance 100. The controller 140 may regulate operation of various components of the refrigerator appliance 100 in response to programming or user manipulation of the user interface panel 142.

The controller 140 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller 140 as disclosed herein is capable of and may be operable to perform any methods and associated method steps as disclosed herein.

The controller 140 may be positioned in a variety of locations throughout refrigerator appliance 100. In the illustrated embodiment, the controller 140 is located within the door 126. In such an embodiment, input/output (“I/O”) signals may be routed between the controller and various operational components of refrigerator appliance 100. In one embodiment, the user interface panel 142 represents a general purpose I/O (“GPIO”) device or functional block. In one embodiment, the user interface 142 includes input components, such as one or more of a variety of electrical, mechanical or electro-mechanical input devices including rotary dials, push buttons, and touch pads. The user interface 142 may include a display component, such as a digital or analog display device designed to provide operational feedback to a user. For example, the user interface 142 may include a touchscreen providing both input and display functionality. The user interface 142 may be in communication with the controller via one or more signal lines or shared communication busses.

The refrigerator appliance 100 may include one or more handle assemblies 150 for opening the one or more doors of the refrigerator appliance. For example, a first handle assembly 150 (e.g., in a horizontal position) may be attached to freezer door 128, a second handle assembly 150 (e.g., in a horizontal position) may be attached to auxiliary door 130, and third and fourth handle assemblies 150 (e.g., in a vertical position) may be attached to refrigerator doors 126. Hereinafter, a single handle assembly 150 will be described in detail in reference to attachment to freezer door 128. It should be understood that the description for handle assembly 150 may apply to one or more handles used to open or close any of the doors or drawers on a domestic appliance (e.g., refrigerator appliance 100).

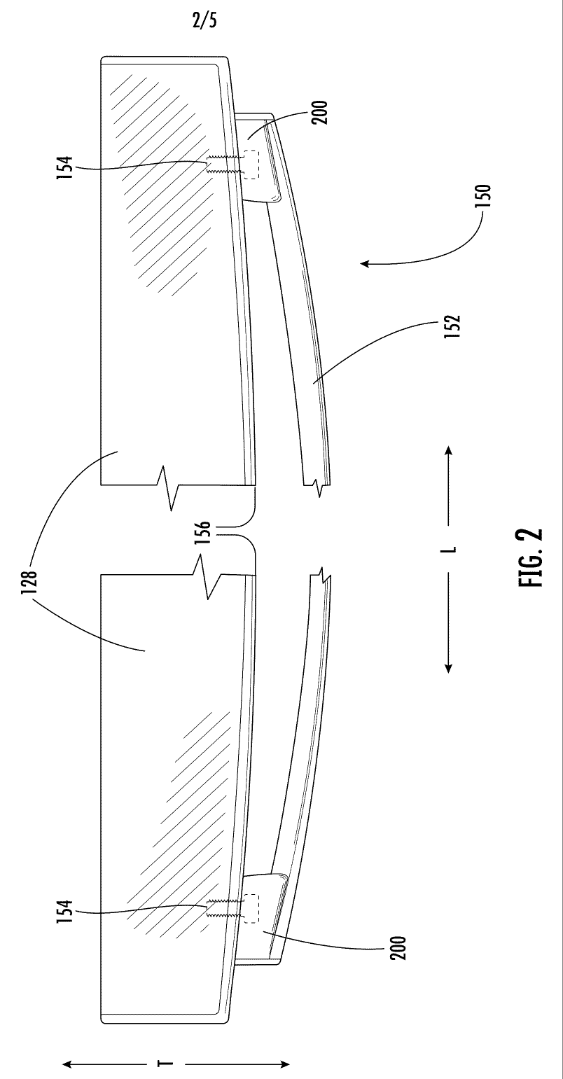

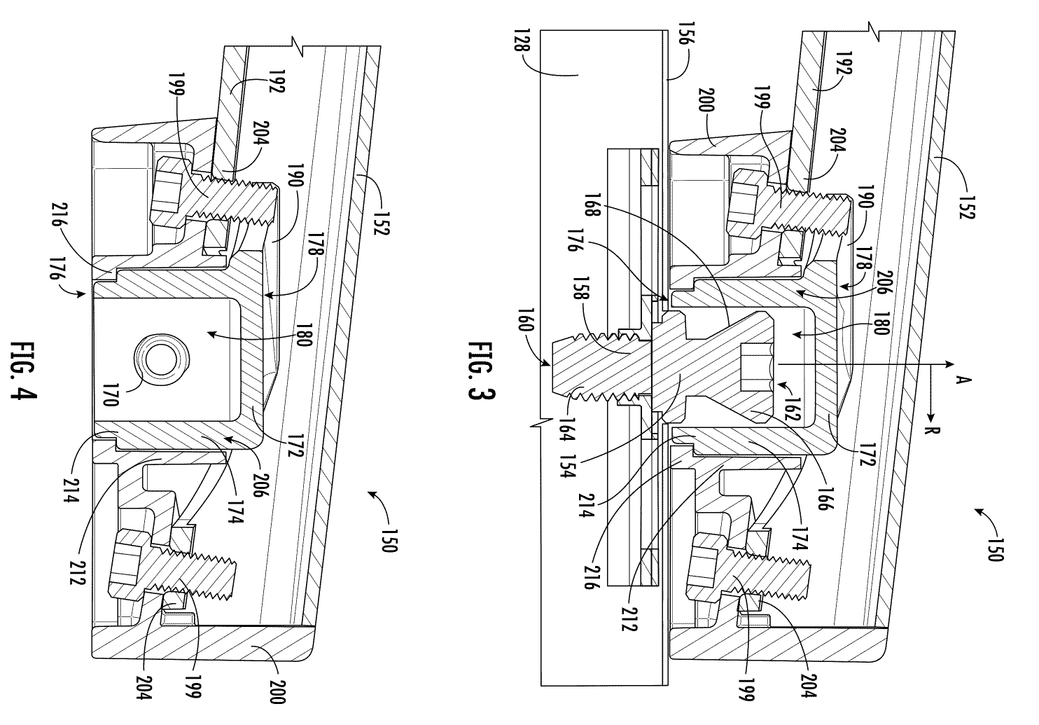

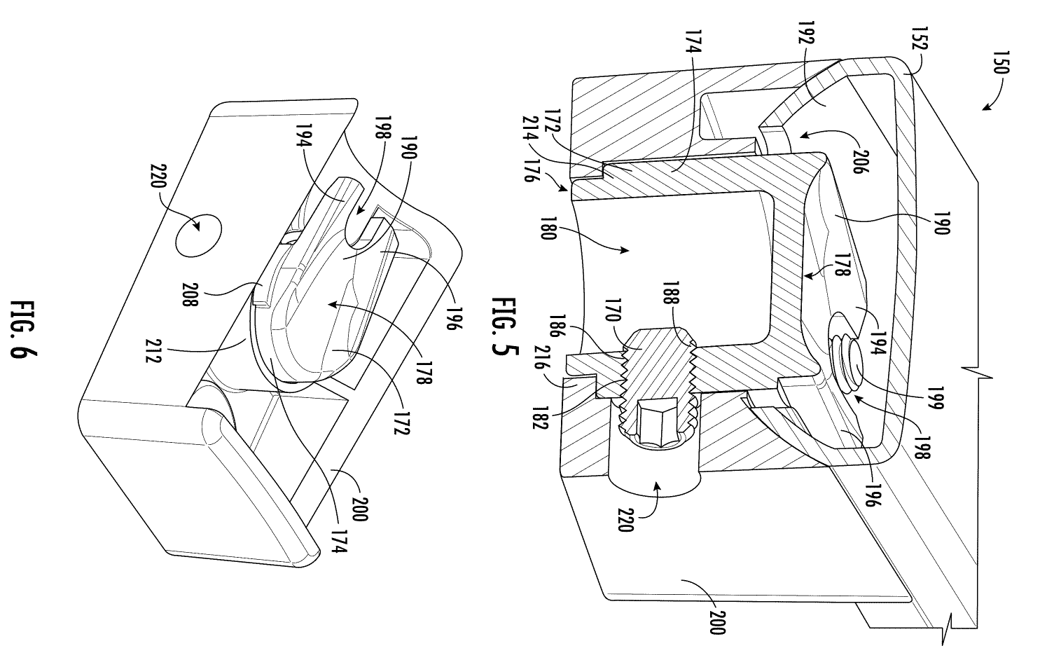

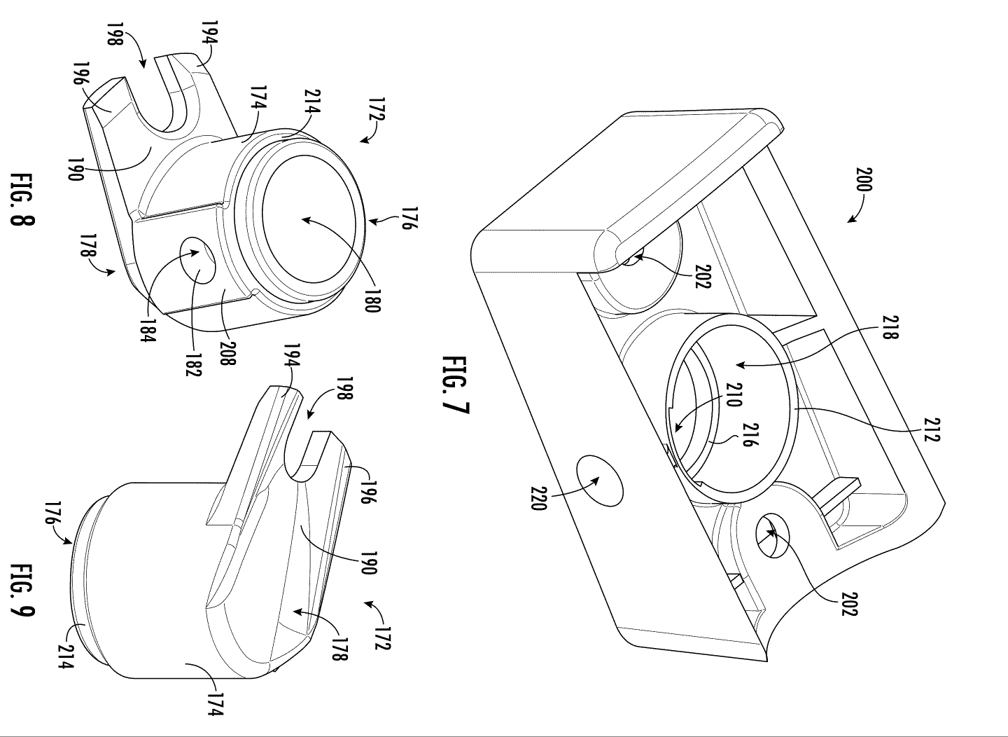

Referring now to FIGS. 2 through 9, a handle assembly 150, and components thereof for a domestic appliance (e.g., refrigerator appliance 100) are provided. For instance, with respect to freezer door 128, the handle assembly 150 may include a handle tube 152 that is generally oriented in the horizontal position (e.g., parallel to the lateral L direction). In general, the handle tube 152 may be a relatively long, slender, generally hollow, tube that is used by a user to grasp the handle assembly 150 and manipulate the position of freezer door 128. In this regard, when installed, the handle tube 152 may be spaced apart from the freezer door 128 such that a user may grasp the handle tube 152 to pull open the freezer door 128. In the illustrated embodiment, handle tube 152 has a closed, generally trapezoidal cross section (e.g., FIG. 5). According to some embodiments, the handle tube 152 may be cylindrical in cross section, while in others, other closed, generally hollow cross section may be used. According to the illustrated exemplary embodiment, the handle tube 152 may be curved.

In some embodiments, the refrigerator appliance 100, and more particularly, the handle assembly 150 may include one or more mount studs 154 to which handle tube 152 may be attached to freezer door 128. More specifically, the mount studs 154 may be embedded within or otherwise secured to the freezer door 128 and may extend from an outer door panel 156 forward along the transverse direction T. The mount studs 154 may generally define an axial direction A and a radial direction R that extends perpendicularly to the axial direction A. For instance, the axial direction A may extend approximately along or parallel to the transverse direction T and the radial direction R may extend approximately along or parallel to the lateral direction L or the vertical direction V. One of ordinary skill in the art will recognize that the same or substantially similar attachment components may be useful in attaching a handle assembly 150 in different orientations, for example in the vertical direction V (for example, as oriented on refrigerator doors 126).

The mount studs 154 may each include a stud body 158 that defines the axial direction A and the radial direction R of the respective mount stud 154. The stud body 158 may extend from a first end 160 to a second end 162 along the axial direction A. The stud body 158 may include a threaded portion 164 disposed at a first end 160 of the stud body 158 and a mount portion 166 disposed at a second end 162 of the stud body 158. The threaded portion 164 may be threadedly engaged with the freezer door 128, such that the stud body 158 may be fixed relative to outer door panel 156. When the mount studs 154 are properly attached to freezer door 128, the mount portion 166 of the mount studs 154 extend outward along the axial direction A from outer door panel 156 to the second end 162.

In some embodiments, the mount studs 154 define an angled contact surface 168 for engaging a threaded fastener 170 (e.g., described in more detail below) to pull the handle assembly 150 firmly into contact with outer door panel 156 and secure handle assembly 150 to freezer door 128. As shown, angled contact surface 168 may define a contact angle measured relative to the axial direction A. The contact angle may be designed such that the force exerted by the threaded fastener 170 pulls handle assembly 150 onto outer door panel 156. For example, according to an example embodiment, contact angle may be between about 10 and 80°, between about 15 and 45°, or about 20°.

As shown, for example, in FIGS. 3 through 6, 8 and 9, the handle assembly 150 may include a bushing 172 that is seated against handle tube 152 and outer door panel 156. The bushing 172 may include a cylindrical wall 174 that extends between a first end 176 and a second end 178. The bushing 172 may define a mount opening 180 through the cylindrical wall 174 for the receipt of mount studs 154. For example, the mount opening may extend through the first end 176 of the cylindrical wall to or toward the second end 178 such that the mount portion 166 of the mount studs 154 may be received or housed within the mount opening 180 defined by the bushing 172. In addition, the bushing 172 may include a threaded wall 182 extended through the cylindrical wall 174. For instance, the threaded wall 182 may extend radially through the cylindrical wall 174 and may define an aperture 184 (e.g., a set screw aperture) for receiving the threaded fastener 170 (e.g., such as a set screw). In particularly, the threaded wall 182 may include a first set of threads 186 for threadedly engaging with a second set of threads 188 of the threaded fastener 170 (e.g., the set screw).

The bushing 172 may also include a retention feature for providing a secondary support for the handle tube 152, such as during a failure condition of the handle tube 152. In particular, the bushing 172 may include a projection 190 disposed at the second end 178 of the bushing 172. The projection 190 may be extended into the hollow portion of the handle tube 152. For example, as shown in FIGS. 3 through 5, the projection 190 may be extended inward (e.g., approximately along the lateral direction L) into the hollow portion of the handle tube 152. In some embodiments, the projection 190 includes a first member 194 and a second member 196 that together define a slot 198 for accommodating a discrete cap screw of one or more cap screws 199 for securing end caps 200 to the handle tube 152. As will be appreciated in more detail below, the projection 190 may be engageable with an inner wall 192 of the handle tube 152. More specifically, the projection 190 may provide a secondary support for the handle tube 152 as it may be engaged with the inner wall 192 during a failure condition of the handle tube 152 to ensure that failure of end caps 200 does not result in the loss of function of the handle assembly 150.

Referring now specifically to FIGS. 2 through 7, the handle assembly 150 may further include one or more end caps 200 that are generally positioned between the outer door panel 156 and the handle tube 152 for securing the handle tube 152 to the freezer door 128 and concealing or capping the ends of the handle tube 152. The one or more cap screws 199 may pass through apertures 202 defined by the end caps 200 and may be received within one or more threaded bosses 204 defined in the handle tube 152. In this manner, by passing the cap screws 199 through the end caps 200 and securing them to the handle tube, the mechanical play between the handle tube 152, the bushing 172, and the freezer door 128 may be eliminated. According to the illustrated embodiment, two cap screws 199 are positioned on opposite sides of the bushing 172 for securing the end cap 200, though any other suitable number of screws or fasteners may be used according to alternative embodiments.

In general, the handle tube 152, the bushing 172, the end caps 200, and other components of the handle assembly 150 may be formed from any suitably rigid material. For example, the handle tube 152 and the bushing 172 may be formed from a metal material and the end caps 200 may be formed from any suitable plastic material. For example, the end caps 200 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics.

According to example embodiments, the handle tube 152, the bushing 172, and the end caps 200 may define any suitable features for facilitating engagement between these components and securing the handle assembly 150 to the freezer door 128. For example, the handle tube 152 may define an alignment aperture 206 for permitting the projection 190 of the bushing 172 into the hollow portion of handle tube 152. As another example, the bushing 172 may include an alignment flange 208 that may be protruded radially outward from the cylindrical wall 174 of the bushing 172. The alignment flange 208 may be received within an alignment recess 210 defined at an inner wall 212 of the end cap 200. In this regard, a proper angular alignment between the bushing 172 and the end cap 200 may be obtained. As yet another example, the bushing 172 may define a circumferential groove 214 at the first end 176 which is received within a shoulder 216 of the inner wall 212 of the end cap 200. According to example embodiments, these features may ensure firm engagement and seating of the handle tube 152, the bushing 172, the end caps 200, and the outer door panel, e.g., such that the bushing 172 and the end cap are seated against the outer door panel 156 in the installed position.

As an illustrative example, to install the handle assembly 150 (e.g., to attach the handle assembly 150 to the freezer door 128), the mount studs 154 may be inserted (e.g., threaded) into the outer door panel 156 of the freezer door 128 at opposing lateral ends of the freezer door 128. The end caps 200 (e.g., including the bushing 172 disposed within a through hole 218 defined by the inner wall 212) and handle tube 152 (e.g., attached to the end caps 200 via the cap screws 199) may be positioned such that the mount portions 166 of the mount studs 154 are disposed within the mount openings 180 of the bushings 172. The threaded fasteners 170 may then be inserted through set screw apertures 220 defined through the end caps 200 and threadedly engaged with the threaded wall 182 of the bushings 172 until the threaded fasteners 170 engages with mount studs 154 to create a firm engagement and secure handle assembly 150 to freezer door 128. The mount studs 154 and the threaded fasteners 170 may be designed such that threaded fasteners 170 are fully recessed within the threaded walls 182 when properly installed. In this regard, the length of threaded fasteners 170 may be selected such that it is concealed within threaded wall 182 if threaded fastener 170 engages angled contact surface 168. It should be appreciated that other attachment methods and fasteners may be used while remaining within the scope of the present subject matter.

Notably, the features of the handle assembly 150 described herein may ensure proper mounting of the handle assembly 150 to the freezer door 128. In addition, these features may ensure that a failure of the end caps 200 does not result in the loss of function of the handle assembly 150. More specifically, as the end caps 200 may be formed from a plastic material (e.g., to minimize or reduce production costs), the end caps 200 may be particularly susceptible to chemical attack and corrosion, e.g., due to harsh cleaning products that the end caps 200 may be exposed to. The chemical attack and corrosion may lead to environmental stress cracking of the plastic material that may result in failure of the plastic end caps 200, and thus separation of the handle tube 152 from the appliance. In the event of an end cap 200 failure (e.g., an end cap failure condition), the projection 190 may be engaged with the inner wall 192 of the handle tube 152, for instance, to prevent the handle assembly 150 from losing all function. In particular, the projection 190 may engage with a rearward portion of the inner wall 192 such that the bushing 172 maintains the attachment of the handle tube 152 to the freezer door 128.,

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A domestic appliance comprising:
a cabinet;
a door providing selective access to an interior of the cabinet; and
a handle assembly attached to the door, the handle assembly comprising:
a handle tube,
an end cap positioned between the door and the handle tube for securing the handle tube to the door, the end cap defining a through hole, and
a bushing received within the through hole, the bushing comprising a projection disposed at an end of the bushing, the projection extended into the handle tube.

2. The domestic appliance of claim 1, wherein the projection is engageable with an inner wall of the handle tube during an end cap failure condition.

3. The domestic appliance of claim 1, wherein the handle assembly further comprises
one or more cap screws securely attaching the end cap to the handle tube.

4. The domestic appliance of claim 3, wherein the projection comprises a first member and a second member each extended inward into a hollow portion of the handle tube, and
wherein the first member and the second member together define a slot for accommodating a portion of a discrete cap screw of the one or more caps screws.

5. The domestic appliance of claim 3, wherein the handle tube defines one or more threaded bosses for receiving the one or more cap screws.

6. The domestic appliance of claim 3, wherein the one or more cap screws comprise two cap screws positioned on opposite sides of the bushing.

7. The domestic appliance of claim 1, wherein the handle assembly further comprises
an alignment flange protruding from a cylindrical wall of the bushing for receipt within an alignment recess defined in the end cap.

8. The domestic appliance of claim 1, wherein the bushing defines a circumferential groove at a first end of the bushing,
wherein the projection is extended from a second end opposite the first end, and
wherein the circumferential groove is received within a shoulder of the end cap.

9. The domestic appliance of claim 1, wherein the handle assembly further comprises
a mount stud extending from the door; and a
a threaded fastener passing through a set screw aperture defined in the bushing to engage the mount stud and secure the bushing to the door.

10. The domestic appliance of claim 1, wherein the bushing extends between a first end and a second end,
wherein the first end of the bushing and the end cap are seated against an outer door panel of the door, and
wherein the projection is extended from the second end of the bushing into the handle tube.

11. The domestic appliance of claim 1, wherein the end cap is formed from a plastic material.

12. The domestic appliance of claim 1, wherein the bushing is formed from a metal material.

13. A handle assembly for a domestic appliance, the domestic appliance comprising a cabinet and a door providing selective access to an interior of the cabinet, the handle assembly comprising:
a handle tube,
an end cap positionable between the door and the handle tube for securing the handle tube to the door, the end cap defining a through hole, and
a bushing received within the through hole, the bushing extending between a first end and a second end, the bushing comprising a projection disposed at the first end, the projection extended into the handle tube,
wherein the projection is engageable with an inner wall of the handle tube during an end cap failure condition.

14. The handle assembly of claim 13, further comprising:
one or more cap screws securely attaching the end cap to the handle tube.

15. The handle assembly of claim 14, wherein the projection comprises a first member and a second member each extended inward into a hollow portion of the handle tube, and
wherein the first member and the second member together define a slot for accommodating a portion of a discrete cap screw of the one or more caps screws.

16. The handle assembly of claim 13, further comprising:
an alignment flange protruding from a cylindrical wall of the bushing for receipt within an alignment recess defined in the end cap.

17. The handle assembly of claim 13, wherein the bushing defines a circumferential groove at a first end of the bushing,
wherein the projection is extended from a second end opposite the first end, and
wherein the circumferential groove is received within a shoulder of the end cap.

18. The handle assembly of claim 13, further comprising:
a mount stud extending from the door; and a
a threaded fastener passing through a set screw aperture defined in the bushing to engage the mount stud and secure the bushing to the door.

19. The handle assembly of claim 13, wherein the bushing extends between a first end and a second end,
wherein the first end of the bushing and the end cap are seated against an outer door panel of the door, and
wherein the projection is extended from the second end of the bushing into the handle tube.

20. The handle assembly of claim 13, wherein the end cap is formed from a plastic material, and
wherein the bushing is formed from a metal material.
